(19) United States
(12) Patent Application Publication
(10) Pub. No.: US 2015/0215504 A1
(43) Pub. Date: Jul. 30, 2015

(54) RECEPTACLE FOR A VIDEO AND/OR IMAGE CAPTURE DEVICE

(71) Applicant: iOgrapher, LLC, San Gabriel, CA (US)

(72) Inventors: David Basulto, San Gabriel, CA (US); Jason Ivey, Irvine, CA (US)

(21) Appl. No.: 14/682,936

(22) Filed: Apr. 9, 2015

Related U.S. Application Data
(63) Continuation-in-part of application No. 13/895,349, filed on May 15, 2013.
(60) Provisional application No. 61/768,751, filed on Feb. 25, 2013.

(51) Int. Cl. H04N 5/225

(52) U.S. Cl. CPC H04N 5/2253

(57) ABSTRACT

An apparatus comprises a receptacle configured to receive a video and/or image capture device. The video and/or image capture device has a connector that connects to a mounting device such that the video and/or image capture device is mountable to a surface during video and/or image capture. Further, the apparatus has a first handle having a first handle top portion that is operably connected to the receptacle and a first handle bottom portion that is operably connected to the receptacle. In addition, the apparatus has a second handle having a second handle top portion that is operably connected to the receptacle and a second handle bottom portion that is operably connected to the receptacle. The apparatus also has a receiver that is operably attached to the receptacle. The receiver receives the video and/or image capture device.

### RELATED APPLICATIONS

This patent application is a Continuation-In-Part application of U.S. patent application Ser. No. 13/895,349, filed on May 15, 2013, entitled RECEPTACLE FOR AN IMAGE CAPTURE COMPUTING DEVICE, which claims priority to U.S. Provisional Patent Application Ser. No. 61/768,751, filed on Feb. 25, 2013, entitled A PLASTIC CASE FOR THE IPAD MINI AND IPAD. IT HAS HANDLES ON THE SIDES, 3 ACCESSORY SHOE AREAS, A TRIPOD MOUNT, AND THE ABILITY TO SCREW ON 37 MM LENSES., which are hereby incorporated by reference in their entireties.

### BACKGROUND

1. Field

This disclosure generally relates to the field of video and image capture. More particularly, the disclosure relates to a receptacle for a video and image capture device.

2. General Background

Current devices that provide both video and image capture have been utilized in the field of video and image capture during various activities. For instance, video and image capture cameras are being utilized by outdoor enthusiasts to capture video and/or images of outdoor activities. Such video and image capture devices typically have a connector that connects to a variety of different mounts, e.g., a flat mount, a curve mount, etc. The mounts vary by the types of surface to which a user wants to attach the video and image capture device. For example, a curved mount may be utilized to attach the video and image capture device to a helmet whereas a flat mount may be utilized to attach the video and image capture device to a skateboard. The mounts typically are adhered to a surface via an adhesive, e.g., a glue. A user can attach a variety of mounts to various surfaces, e.g., a helmet, a skateboard, etc., and then connect and disconnect the video and image capture device to various surfaces for video and image capture.

Users typically also utilize such video and image capture devices for video and image capture without the devices being connected via mounts. For example, a user may mount the video and image capture device to a skateboard for a portion of an outdoor video, but then disconnect the video and image capture device during skateboarding or after the skateboarding action has been completed to capture video of different scenery that may not be able to be captured from the viewpoint of a mounted video and image capture device. The user typically then has to use one or two hands to hold the video and image capture device to perform the video and image capture of the different scenery.

The video and/or image quality of the video and/or images captured by the user that is holding the video and/or image capture device is typically less than the quality of the video and/or images captured by the mounted video and/or image capture device since the use of one or two hands to hold what is typically a relatively small video and/or image capture device, e.g., 1.7 inches by 2.4 inches, is significantly less stable than a mounting device that mounts the video and image capture device to a surface. For example, a user may want to capture a video during skateboarding from shoulder level rather than the level of the surface of the skateboard. The hands of the user can hold the video and image capture device during skateboarding to capture such a video, but will typically wobble quite easily during movement of the skateboard. Even if the skateboard is not moving, the video and image capture device may wobble as a result of the small dimensions of the video and image capture device, e.g., a user typically has difficulty holding such a small device steady during video and image capture even from a position in which the skateboard is immobile.

Therefore, current video and image capture devices that are mountable to a surface through a connector do not provide adequate stability for users that disconnect the video and image capture devices for performance of video and image capture with one or two hands. As a result, current video and image capture devices provide limited image and video quality.

### SUMMARY

In one aspect of the disclosure, an apparatus is provided. The apparatus has a receptacle configured to receive a video capture device. The video capture device has a connector that connects to a mounting device such that the video capture device is mountable to a surface during video capture. Further, the apparatus has a first handle having a first handle top portion that is operably connected to the receptacle and a first handle bottom portion that is operably connected to the receptacle. In addition, the apparatus has a second handle having a second handle top portion that is operably connected to the receptacle and a second handle bottom portion that is operably connected to the receptacle. The apparatus also has a receiver that is operably attached to the receptacle. The receiver receives the video capture device.

In another aspect of the disclosure, an apparatus is provided. The apparatus has a receptacle configured to receive an image capture device. The image capture device has a connector that connects to a mounting device such that the image capture device is mountable to a surface during image capture. Further, the apparatus has a first handle having a first handle top portion that is operably connected to the receptacle and a first handle bottom portion that is operably connected to the receptacle. In addition, the apparatus has a second handle having a second handle top portion that is operably connected to the receptacle and a second handle bottom portion that is operably connected to the receptacle. The apparatus also has a receiver that is operably attached to the receptacle. The receiver receives the image capture device.

In yet another aspect of the disclosure, an apparatus is provided. The apparatus has a receptacle configured to receive a video and/or image capture device. The video and/or image capture device has a connector that connects to a mounting device such that the video and/or image capture device is mountable to a surface during video and/or image capture. Further, the apparatus has a first handle having a first handle top portion that is operably connected to the receptacle and a first handle bottom portion that is operably connected to the receptacle. In addition, the apparatus has a second handle having a second handle top portion that is operably connected to the receptacle and a second handle bottom portion that is operably connected to the receptacle. The apparatus also has a receiver that is operably attached to the receptacle. The receiver receives the video and/or image capture device.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a front view of an image capture computing device receptacle.

FIG. 2 illustrates a back view of the image capture computing device receptacle.

FIG. 3 illustrates a side view of the receiving means.

FIG. 4 illustrates a front view of the image capture computing device receptacle with a mobile computing device secured to the image capture computing device receptacle.

FIG. 5 illustrates a front view of the image capture computing device receptacle 100 with the mobile computing device secured to the image capture computing device receptacle and the image capture computing device receptacle having a bottom handle.

FIG. 6 illustrates a front view of the image capture computing device receptacle with the mobile computing device secured to the image capture computing device receptacle and the image capture computing device receptacle only having the right handle for a handle.

FIG. 7 illustrates a front view of an image capture computing device receptacle that is configured to receive a smartphone.

FIG. 8 illustrates a back view of the image capture computing device receptacle illustrated in FIG. 7.

FIG. 9A illustrates a front view of a video and/or image capture device configuration.

FIG. 9B illustrates a back view of the video and/or image capture device configuration illustrated in FIG. 9A.

FIG. 10 illustrates a front view of the video and/or image capture device configuration illustrated in FIGS. 9A and 9B without the video and/or image capture device configuration being connected to the receptacle.

FIG. 11 illustrates a side view of the video and/or image capture device configuration illustrated in FIGS. 9A and 9B with a through hole.

### DETAILED DESCRIPTION

A receptacle for an image capture computing device is provided. The image capture computing device is received by the receptacle. A user then grasps the receptacle and motions the receptacle to a position for image capture. The receptacle has handles that provide for stabilization of the receptacle and the image capture computing device. As a result, users performing image capture have the ability to capture still images and/or video images with stabilization. In contrast with heavy receptacles that do not have handles, the receptacle for the image capture computing device provides a lightweight configuration that provides stabilization for an image capture computing device.

Further, the receptacle may have additional components that allow the user performing image capture to vary image capture conditions. For example, the receptacle may receive a variety of lenses that may be utilized to vary viewing conditions. Further, various lighting and/or audio equipment may be positioned on the receptacle to vary lighting and/or audio conditions. The receptacle may also have a tripod component so that the receptacle may be stabilized with a tripod to minimize motion of the image capture computing device during image capture.

In addition, a receptacle for a video and/or image capture device is provided. The video and/or image capture device may capture only video, only images, or both video and images. The receptacle receives the video and/or image capture device when the video and/or image capture device is not adhered directly to a surface. A user can utilize one or more handles positioned on a frame of the receptacle to motion the receptacle for video and/or image capture. For example, a user can mount the video and/or image capture device directly to a skateboard and capture video while skateboarding from the viewpoint of the front of the skateboard. The user may want to halt the skateboard after a certain time period, disconnect the video and/or image capture device from a connector to the mounting device that mounted the video and/or image capture device to the skateboard, and then connect the video and/or image capture device to the receptacle. The user can then grasp one or more handles of the frame of the receptacle to capture video from shoulder level for the remainder of the video. The user may grasp the receptacle via the one or more handles during skateboarding to capture video during motion or may grasp the receptacle via the one or more handles while halted.

The frame for the receptacle for the video and/or image capture device may also comprise additional connectors so that additional components may be mounted to the frame of the receptacle to further facilitate video and/or image capture by the user. For example, the frame may have a connector for a display device. The user may connect the display device to the frame and to the video and/or image capture device. The display device may be utilized by the user to preview scenery for video and/or image capture, display menus items for controlling the video and/or image capture device, etc. The frame may also have a connector for a lighting device to connect a lighting device that provides additional lighting during video and/or image capture. Further, the frame may have a microphone connector that connects a microphone to the video and/or image capture device so that the user can enhance the audio that is captured during video capture. For example, the user may want to capture enhanced audio of a skateboard travelling on different surfaces.

The receptacle for the video and/or image capture device allows a user to obtain enhanced stability for video and/or image capture as the user can grasp the one or more handles during an activity involving motion of the user and/or the video and/or image capture device. Further, the receptacle for the video and/or image capture device allows a user to obtain enhanced stability for video and/or image capture as the user can disconnect the video and/or image capture device from a surface after motion has completed, grasp the one or more handles, and perform video and/or image capture. As a result, the user is able to effectively change the positioning of the video and/or image capture device from a mounted position on a mobile surface to a surface that is stable, but that is motioned by the user. Therefore, the user is able to transition from one surface to another surface in a manner that maintains stability on both surfaces to minimize effects on the quality of the video and/or images resulting from video and/or image capture with different configurations.

The receptacle for the video and/or image capture device may also be mounted directly on a surface. For example, the frame of the receptacle for the video and/or image capture device may be directly mounted to a skateboard. The user may perform video and/or image capture at the surface level of the skateboard by connecting the video and/or capture device to the receptacle. The user may then perform video and/or image capture at shoulder level by disconnecting the receptacle from the skateboard and holding the receptacle via one or more handles at shoulder level. As a result, the user does not have to disconnect the video and/or image capture device during transitions from different viewpoints.

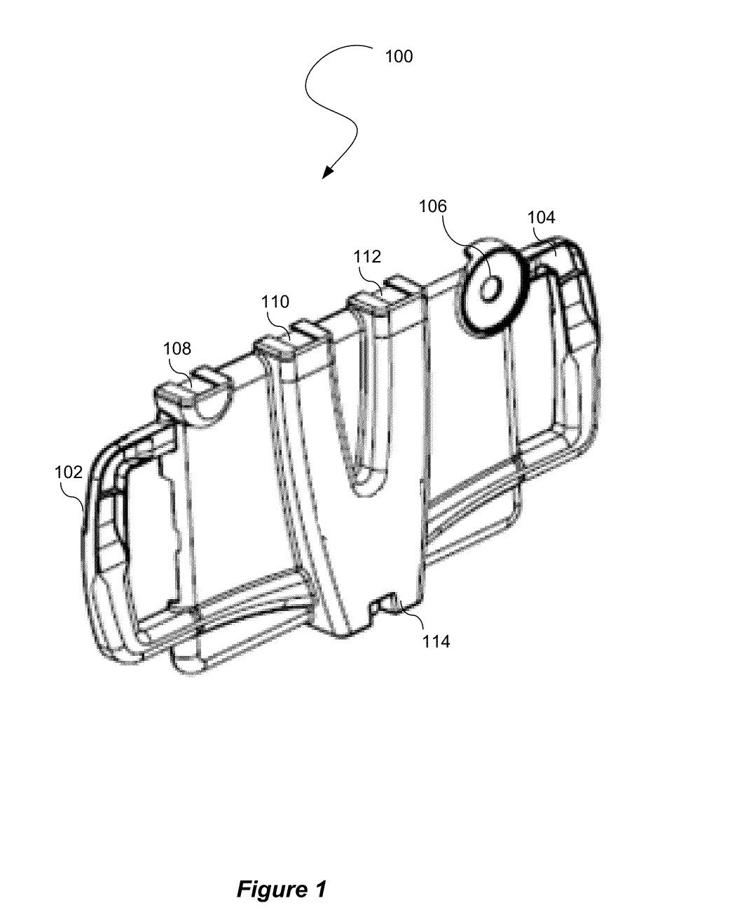

FIG. 1 illustrates a front view of an image capture computing device receptacle 100. In one embodiment, the image capture computing device 100 includes a plurality of handles, e.g., a right handle 102 and a left handle 104. The front of the image capture computing device receptacle 100 is illustrated from the perspective of what another user views if in front of the image capture computing device 100 when an image is captured by a user such as a photographer. The right handle 102 and the left handle 104 allow the user to perform image capture with minimal wobbling. As a result, the photographer is able to perform image capture with more stabilization and accuracy than without the image capture computing device receptacle 100. Although the right handle 102 and the left handle 104 are illustrated, the handles may be in other locations, e.g., a top handle and a bottom handle. Further, a single handle or more than two handles may be utilized. The right handle 102 and the left handle 104 are provided merely for illustrative purposes.

The image capture computing device receptacle 100 also has an aperture 106. The aperture 106 is configured so that an image capture component, e.g., a lens of a mobile image capture computing device, may be positioned to capture images through the aperture 106. In one embodiment, the aperture 106 is configured to be in substantial proximity to the image capture component. For example, the aperture may be narrow enough to only be positioned over the lens to minimize reflection.

In another embodiment, the image capture computing device receptacle 100 has a plurality of accessory receiving means. As an example, the image capture computing device receptacle 100 has a receiving means 108, a receiving means 110, a receiving means 112, and a receiving means 114. The various receiving means may be utilized to receive accessories such as lighting devices, e.g., lamps, audio devices, e.g., microphones, additional lenses, e.g., wide angle lenses, tripods, and/or the like. For example, the receiving means 114 may receive a tripod mount to provide further stabilization for the image capture computing device receptacle 100 with a tripod. A single or different quantity of receiving means may be utilized from that illustrated in FIG. 1.

In one embodiment, the right handle 102 and the left handle 104 are integrated within the same frame as the image capture computing device receptacle 100. In other words, a single molding may be utilized for the frame and the handles. In an alternative embodiment, the right handle 102 and the left handle are detachable from the frame.

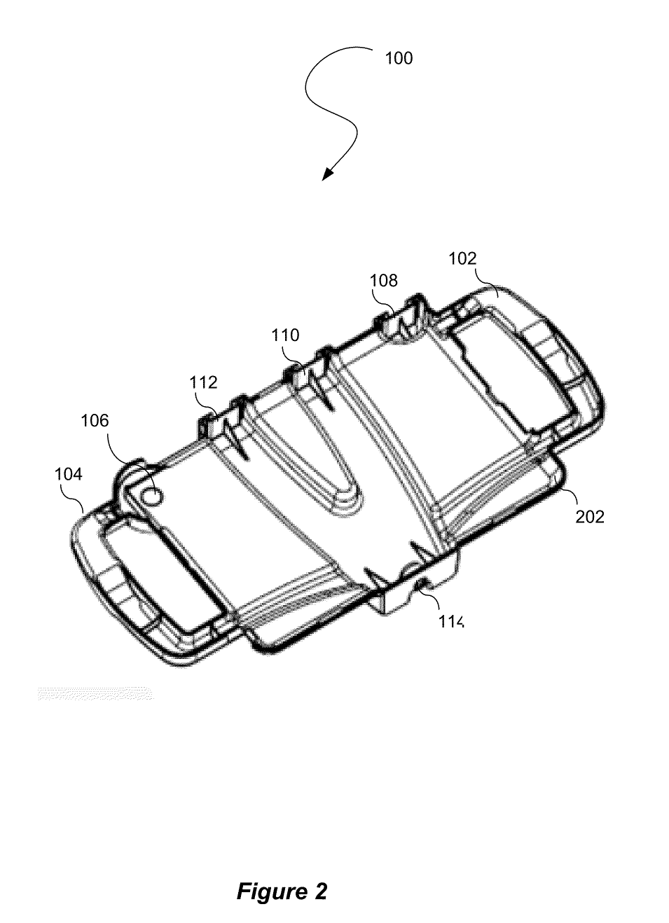

FIG. 2 illustrates a back view of the image capture computing device receptacle 100. The back view is from the perspective of the photographer that is placing the mobile computing device in the image capture computing device receptacle 100. In one embodiment, the image capture computing device receptacle 100 has a receiving means for receiving the image capture computing device receptacle 100. An example of the receiving means is the lip 202. The lip 202 may be positioned throughout all of the frame or at least a portion of the frame. A photographer may then snap the mobile computing device within the lip to secure the mobile computing device in the image capture computing device receptacle 100. As a result, the photographer may easily snap the mobile computing device into position. The lip is only an example of the receiving means. The receiving means may also be a fastening means such as a screw, bolt, nail, clip, and/or the like.

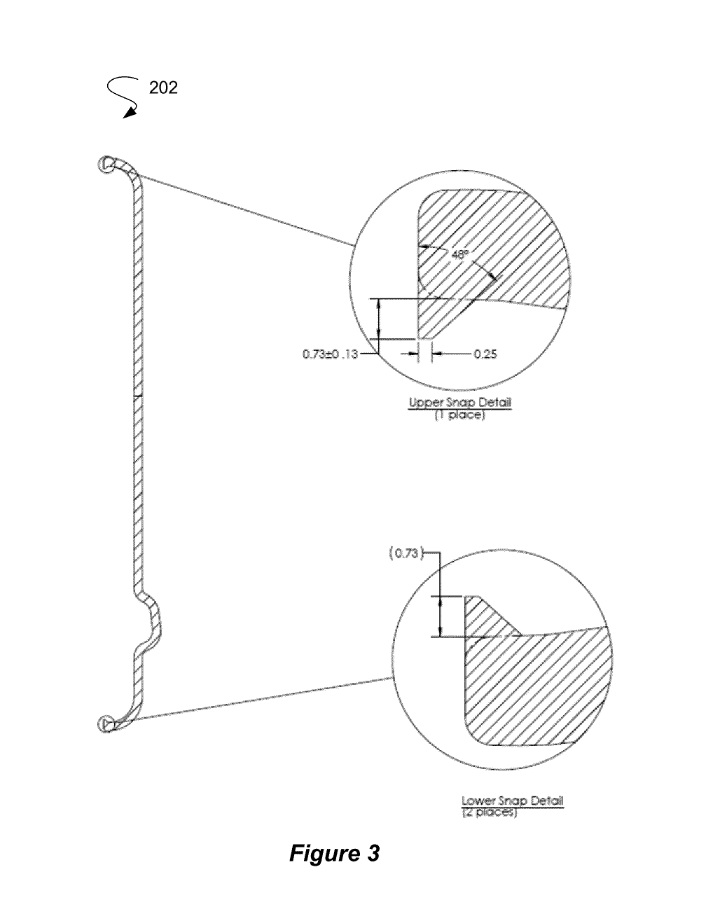

FIG. 3 illustrates a side view of the receiving means 202. The receiving means 202 is illustrated as a lip only for illustrative purposes as various other receiving means may be utilized.

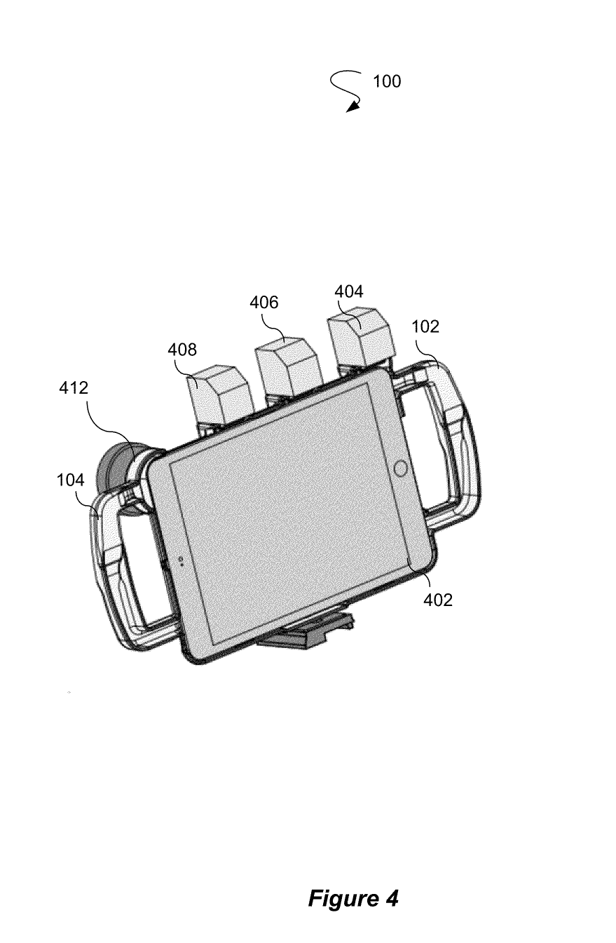

FIG. 4 illustrates a front view of the image capture computing device receptacle 100 with a mobile computing device 402 secured to the image capture computing device receptacle 100. The mobile computing device 402 may be a tablet device, smartphone, or any other mobile device. Further, the mobile computing device 402 may have an image capture component, e.g., a built in camera, for still or motion image capture. Various accessories 404, 406, and 408 may be connected to the receiving means 108, 110, and 112. The receiving means 108, 110, and 112 may be a lip, screw, bolt, nail, clip, and/or the like. Further, a lens accessory 412 is positioned over the aperture 106.

Although a frame single frame is illustrated in FIG. 4, multiple frames may alternatively be utilized to secure the mobile computing device 402. In other words, the image capture computing device receptacle 100 may comprise multiple parts such as a front portion and a back portion to secure the mobile computing device 402 to the image capture computing device receptacle 100. Accordingly, the image capture computing device receptacle 100 is not limited to a single frame as multiple frames may alternatively be utilized.

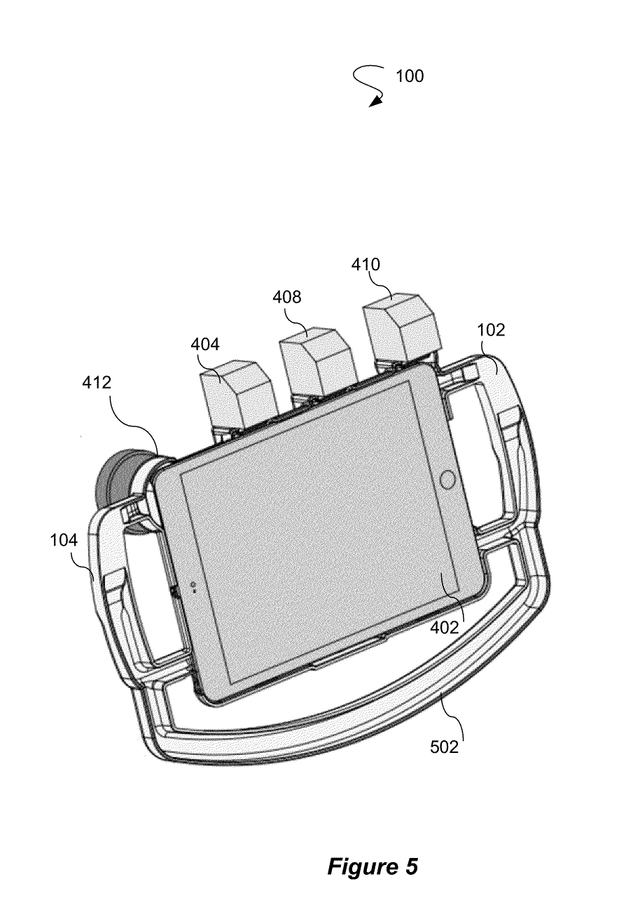

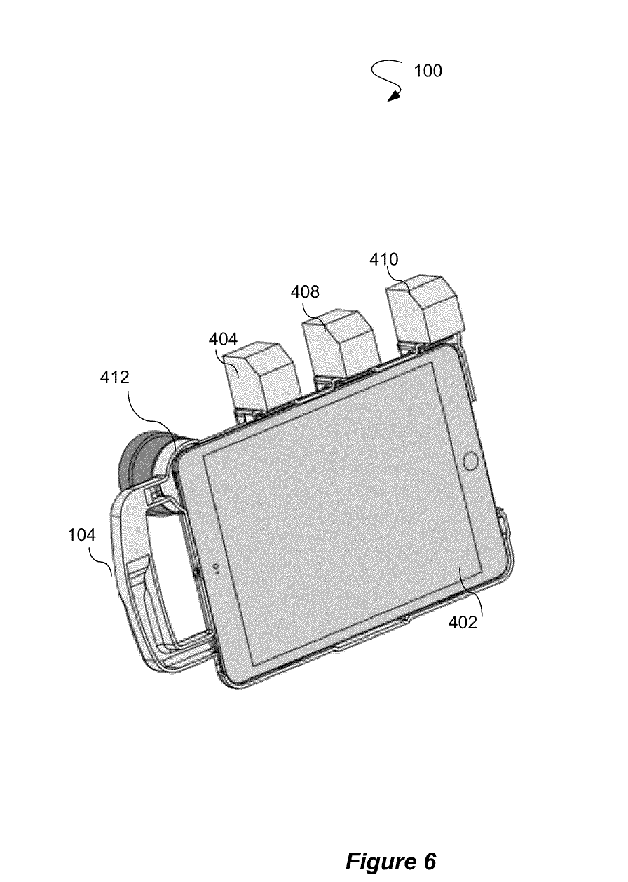

Although FIGS. 1-4 illustrated two handles, a single handle or more than two handles may be utilized. FIG. 5 illustrates a front view of the image capture computing device receptacle 100 with the mobile computing device 402 secured to the image capture computing device receptacle 100 and the image capture computing device receptacle 100 having a bottom handle 502. Alternatively, the right handle 102, the left handle 104, and the bottom handle 502 may be considered a single handle. Further, FIG. 6 illustrates a front view of the image capture computing device receptacle 100 with the mobile computing device 402 secured to the image capture computing device receptacle 100 and the image capture computing device receptacle 100 only having the left handle 104 for a handle.

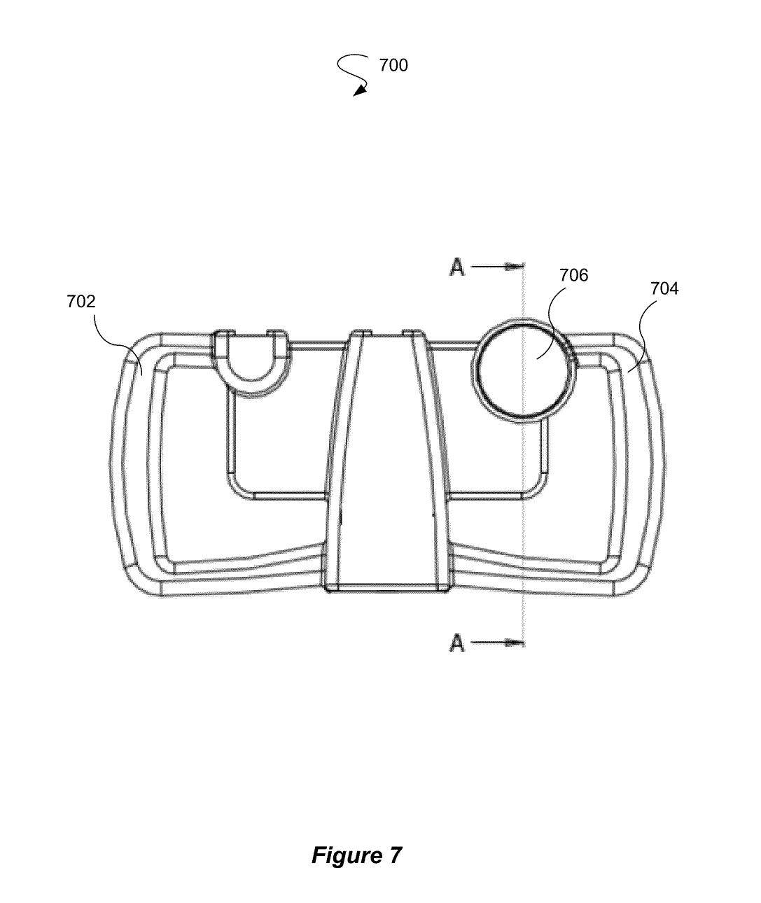

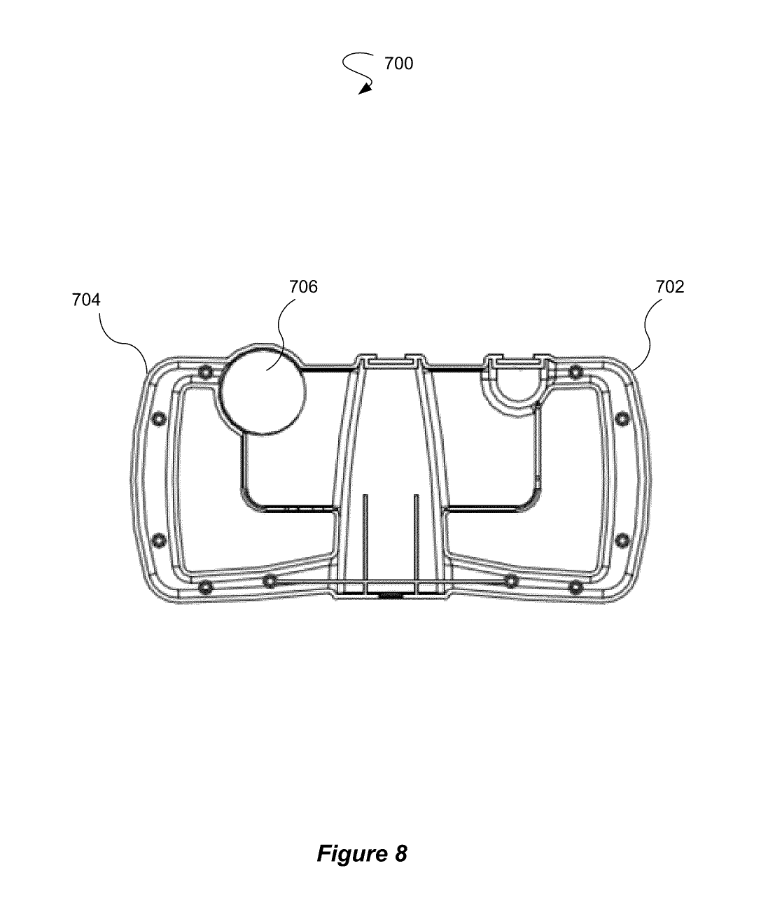

Although FIGS. 4-6 illustrate the mobile computing device 402 as a tablet device, a smartphone may alternatively be utilized. Accordingly, FIG. 7 illustrates a front view of an image capture computing device receptacle 700 that is configured to receive a smartphone. The image capture computing device receptacle 700 has a right handle 702 and a left handle 704. The image capture computing device receptacle 700 also has an aperture 706. FIG. 8 illustrates a back view of the image capture computing device receptacle 700 illustrated in FIG. 7.

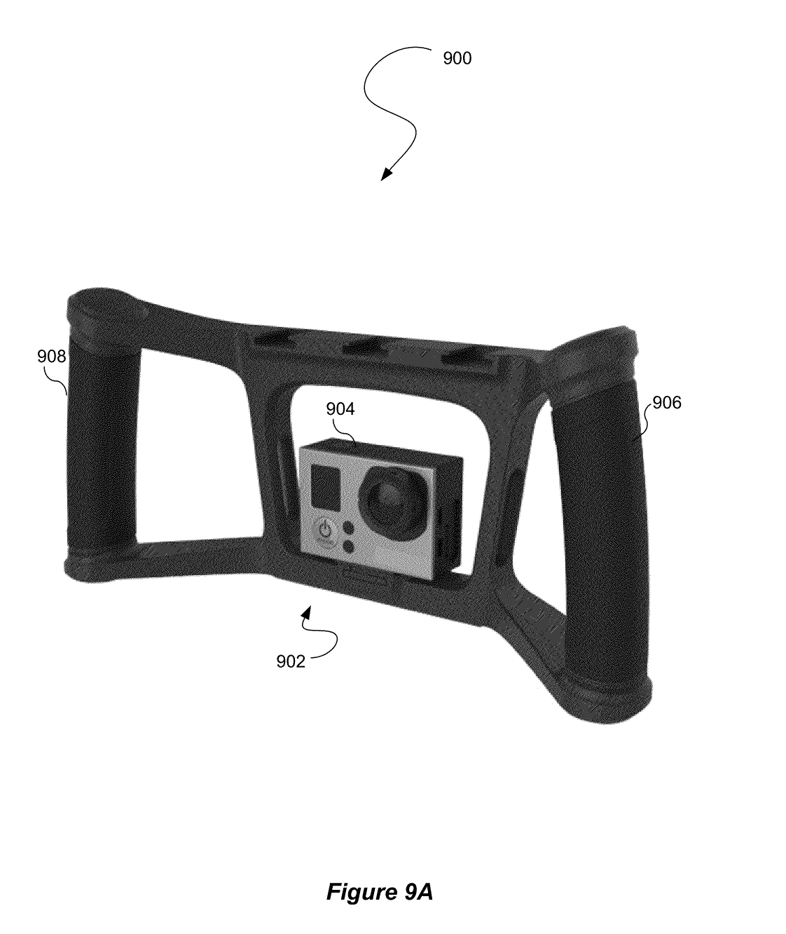

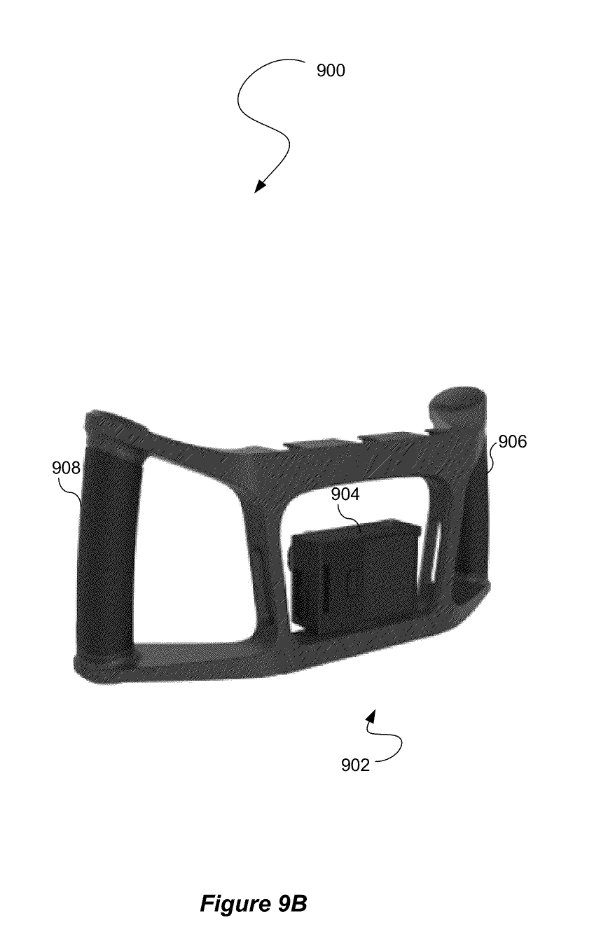

FIG. 9A illustrates a front view of a video and/or image capture device configuration 900. The video and/or image capture device configuration 900 has a video and/or image capture device receptacle 902 that receives a video and/or image capture device 904. The video and/or image capture device receptacle 902 has a right handle 906 and a left handle 908. Other portions of the receptacle 902 may be utilized to connect a display device, a lighting device, a microphone device, etc. FIG. 9B illustrates a back view of the video and/or image capture device configuration 900 illustrated in FIG. 9A.

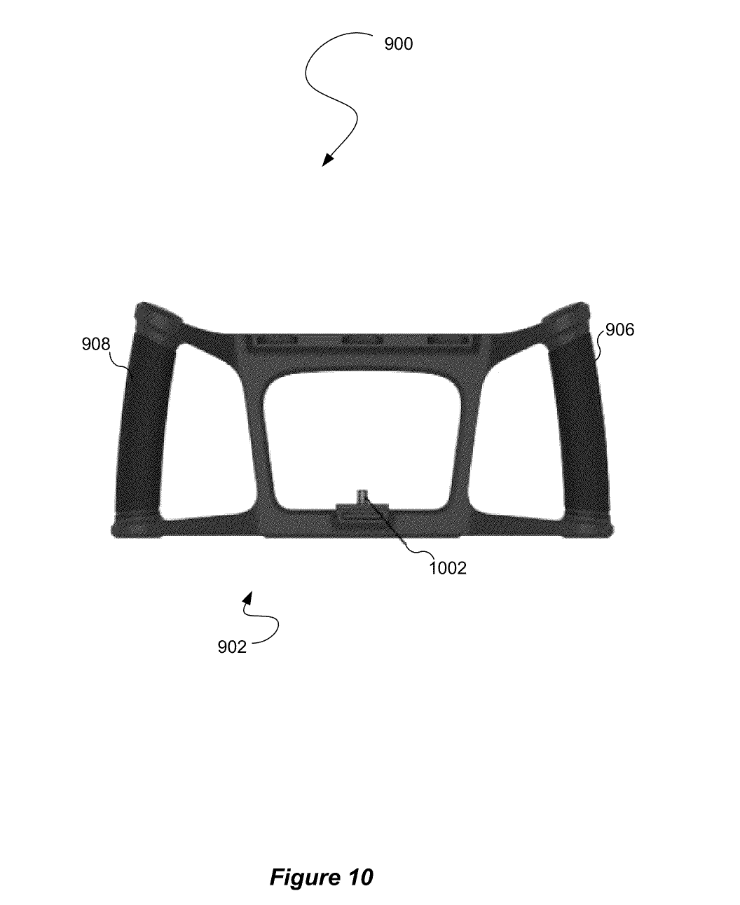

FIG. 10 illustrates a front view of the video and/or image capture device configuration 900 illustrated in FIGS. 9A and 9B without the video and/or image capture device configuration 900 being connected to the receptacle 902. A connector 1002 is illustrated as the connection mechanism for connecting the video and/or image capture device to the receptacle 902. The connector 1002 can be a screw, clip, adhesive, or other form of connection mechanism. Further, an additional connector 1002 may be utilized to connect the bottom of the receptacle 902 to a surface, e.g., a surface of a skateboard. For example, the additional connector 1002 may be a screw that connects to a mounting device that connects to a surface of a skateboard. For instance, the additional connector 1002 may be a clip mechanism that the user can unclip to disconnect the entire receptacle 902 from the surface to which it is mounted, e.g., a skateboard surface, so that the user can then grasp the handles and motion the receptacle 902 to perform video capture. Alternatively, the additional connector 1002 may be an adhesive that connects the receptacle 902 to the surface. The user then removes the video and/or image capture device 904 from the receptacle 902 to grasp either or both handles 906 and 908 and perform video and/or image capture.

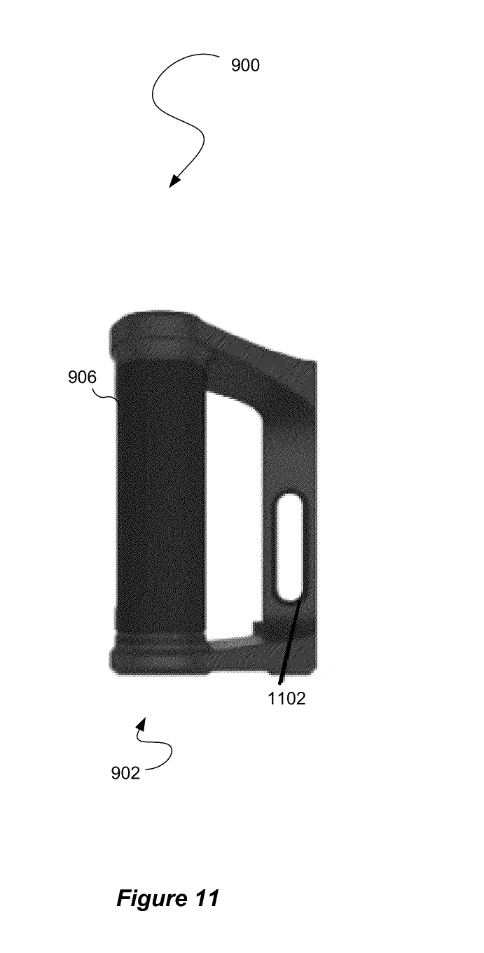

FIG. 11 illustrates a side view of the video and/or image capture device configuration 900 illustrated in FIGS. 9A and 9B with a through hole 1102. The through hole 1102 allows cables, wires, etc. to go from the video and/or image capture device 902 to other components, storage devices, power outlets, etc.

Although the right handle 906 and the left handle 908 are illustrated in FIGS. 9A and 9B, a variety of other configurations may be utilized for operation with the receptacle 902. For example, a top handle and/or a bottom handle may be utilized. Also, only one handle or more than two handles may be utilized.

Further, although the connector 1002 is illustrated in FIG. 10 as being at the center of the receptacle 902, the connector 1002 may be positioned at a variety of locations on the receptacle 902. For instance, the connector 1002 may be positioned at one of the handles 906 and 908. For example, the video and/or image capture device 904 may be connected to the right handle 906 so that a user can operate the video and/or image capture device 904 while grasping the right handle 906. Further, other components, e.g., a display device, a lighting device, a microphone, etc. can be connected to a handle 906 or 908.

A variety of types of materials may be utilized for the image capture computing device receptacles. For example, plastic, carbonite, metal, or the like may be utilized.

It is understood that the apparatuses described herein may also be applied in other types of apparatuses. Those skilled in the art will appreciate that the various adaptations and modifications of the embodiments of the apparatuses described herein may be configured without departing from the scope and spirit of the apparatuses. Therefore, it is to be understood that, within the scope of the appended claims, the present apparatuses may be practiced other than as specifically described herein.

We claim:

1. An apparatus comprising:
a receptacle configured to receive a video capture device, the video capture device having a connector that connects to a mounting device such that the video capture device is mountable to a surface during video capture;
a first handle having a first handle top portion that is operably connected to the receptacle and a first handle bottom portion that is operably connected to the receptacle;
a second handle having a second handle top portion that is operably connected to the receptacle and a second handle bottom portion that is operably connected to the receptacle; and
a receiver that is operably attached to the receptacle, the receiver receiving the video capture device.

2. The apparatus of claim 1, wherein the mounting device comprises an adhesive that adheres to the surface.

3. The apparatus of claim 1, wherein the receiver is the mounting device.

4. The apparatus of claim 1, further comprising a frame that comprises the receptacle, the first handle, and the second handle.

5. The apparatus of claim 4, wherein the frame further comprises a receiver for a display device.

6. The apparatus of claim 4, wherein the frame further comprises a receiver for a lighting device.

7. The apparatus of claim 4, wherein the frame further comprises a receiver for a microphone.

8. The apparatus of claim 4, wherein the frame further comprises a mounting connector that connects to a mounting device that mounts the frame to the surface.

9. The apparatus of claim 1, wherein the receiver is operably attached to the receptacle through the first handle.

10. The apparatus of claim 1, wherein the receiver is operably attached to the receptacle through the second handle.

11. The apparatus of claim 1, wherein the receptacle has an aperture through which a lens of the video capture device is positioned.

12. An apparatus comprising:
a receptacle configured to receive an image capture device, the image capture device having a connector that connects to a mounting device such that the image capture device is mountable to a surface during image capture;
a first handle having a first handle top portion that is operably connected to the receptacle and a first handle bottom portion that is operably connected to the receptacle;
a second handle having a second handle top portion that is operably connected to the receptacle and a second handle bottom portion that is operably connected to the receptacle; and
a receiver that is operably attached to the receptacle, the receiver receiving the image capture device.

13. The apparatus of claim 12, wherein the mounting device comprises an adhesive that adheres to the surface.

14. The apparatus of claim 12, wherein the receiver is the mounting device.

15. The apparatus of claim 12, further comprising a frame that comprises the receptacle, the first handle, and the second handle.

16. The apparatus of claim 15, wherein the frame further comprises a receiver for a display device.

17. The apparatus of claim 15, wherein the frame further comprises a receiver for a lighting device.

18. The apparatus of claim 15, wherein the frame further comprises a receiver for a microphone.

19. An apparatus comprising:
a receptacle configured to receive a video and/or image capture device, the video and/or image capture device having a connector that connects to a mounting device such that the video and/or image capture device is mountable to a surface during video and/or image capture;
a first handle having a first handle top portion that is operably connected to the receptacle and a first handle bottom portion that is operably connected to the receptacle;
a second handle having a second handle top portion that is operably connected to the receptacle and a second handle bottom portion that is operably connected to the receptacle; and
a receiver that is operably attached to the receptacle, the receiver receiving the video and/or image capture device.

20. The apparatus of claim 19, wherein the mounting device comprises an adhesive that adheres to the surface.
